(19) United States
(12) Patent Application Publication
(10) Pub. No.: US 2026/0101003 A1
(43) Pub. Date: Apr. 9, 2026

(54) ARTIFICIAL INTELLIGENCE ASSISTANCE FOR CONTACT CENTERS

(71) Applicant: Zoom Communications, Inc., San Jose, CA (US)

(72) Inventors: David Robert DeLorimier, Annandale, VA (US); Kwang Ok, Bothell, WA (US); Xue Zhao, San Jose, CA (US)

(73) Assignee: Zoom Communications, Inc., San Jose, CA (US)

(21) Appl. No.: 19/190,310

(22) Filed: Apr. 25, 2025

Related U.S. Application Data
(60) Provisional application No. 63/704,364, filed on Oct. 7, 2024.

(51) Int. Cl. H04M 3/51; G06Q 10/0639

(52) U.S. Cl. CPC H04M 3/5175; G06Q 10/06393; H04M 2203/401; H04M 2203/558

(57) ABSTRACT

Systems and methods for providing AI assistance for a contact center are provided. A communication platform establishes a communication session between a contact center device and a client device. The communication platform accesses communication data associated with the contact center device and the client device during the communication session. The communication platform detects an intent of a user associated with the client device based on a set of communication data. The communication platform retrieves knowledge data from a knowledge base based on the intent. The communication platform generates a suggested response to the user based on the knowledge data using a generative model. The communication platform provides the suggested response to the contact center device during the communication session.

### CROSS-REFERENCE TO RELATED APPLICATIONS

This application claims priority from U.S. Provisional Patent Application No. 63/704,364, filed Oct. 7, 2024, titled “Artificial Intelligence Assistance for Contact Centers,” the entirety of which is hereby incorporated by reference.

### FIELD

The present application generally relates to virtual communication and more specifically relates to artificial intelligence assistance for contact centers.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides chat and videoconferencing functionality to various client devices.

FIG. 2 shows an example system in which a video conference provider provides chat and videoconferencing functionality to various client devices.

FIG. 3 shows an example system for facilitating virtual communication between client devices and contact centers.

FIG. 4 shows an example system that is configured to provide AI assistance for contact centers.

FIG. 5 shows an example GUI for a communication session on a contact center device.

FIG. 6 shows an example method for providing AI assistance for contact centers.

FIG. 7 shows an example computing device suitable for use with example systems and methods for AI assistance for contact centers.

### DETAILED DESCRIPTION

Examples are described herein in the context of AI assistance for contact centers. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

An agent at a contact center associated with an enterprise usually needs to manually search one or more knowledge bases to answer a question from a user associated with the enterprise. In addition, a contact center agent generally needs to navigate other systems in order to help solve the user's issue. For example, the agent needs to obtain the user information or background from a customer relationship management system (CRM). The agent may also need to search a third-party database to obtain certain data to solve the user's issue. The existing process is time consuming and inefficient, which also negatively impacts user experience. Moreover, the existing process lacks supervision and evaluation for individual agents'performances during interactions between the agents and users.

To assist contact center agents when they engage with users, it is desirable for a communication platform to provide an intelligent assistance system for contact centers. A contact center is associated with an enterprise that provides products or services. Users of the contact center are customers of the enterprise. The intelligent assistance system for a contact center provided by the communication platform includes a knowledge base, a query processing engine, an answer generation engine, and a supervision engine.

The knowledge base includes knowledge data associated with an enterprise and scripts used for solving known user issues. The knowledge data includes articles, webpages, reports, or any suitable formats of data associated with the enterprise. The scripts can be pre-generated by operators associated with the enterprise, including steps for solving known user issues.

The query processing engine is configured to detect a user intent based on a user utterance and its context during a communication session with a contact center agent. The query processing engine uses or implements one or more intent models. The intent models are customized for a corresponding enterprise based on knowledge data associated with the corresponding enterprise. The context can include interactions or utterances prior to the current utterance and user information extracted from a customer relationship management (CRM) system associated with the enterprise. The query processing engine also includes a generative AI model to rewrite a user query to accurately reflect the user's intent.

The intelligence assistance system identifies a script in a knowledge database to solve the user's issues based on the intent detected by the intent model. The answer generation engine uses or implements an AI model (e.g., large language model (“LLM”) or natural language processing (NLP) model) or a logic model to analyze the conversation between a contact center agent and a user to guide the contact center agent to the relevant next step based on the script. In some examples, a step in the script for solving the user's issues involves or references multiple knowledge base articles. The answer generation engine uses a generative AI model based on the articles, the intent, and the rewritten query to generate a suggested answer or response in a timely manner. With the suggested answer, the agent can keep the conversation moving without interruption or delay.

The supervision engine monitors the communication between the agent and the user to notify a contact center supervisor of certain anomalies or certain situations for the supervisor to intervene. The anomalies can be pre-defined in various categories. For example, the supervision engine monitors the user sentiment (e.g., negative, positive, neutral, angry, happy). The supervision engine can use or implement a ML model to generate a sentiment score. For example, the higher the score is, the more positive the sentiment is. If the sentiment score is below a predetermined threshold, the supervisor engine generates and transmits a notification to the supervisor for intervention. The supervision engine also monitors the agent behavior or performance. For example, the supervision engine evaluates how much (e.g., 80% of the time) the agent has followed the suggested answers during the communication session and corresponding effects on the user. The supervision engine can also prompt the agent to provide feedback on the suggested answers.

Thus, the example intelligent assistance system can improve efficiency and handle time to solve user issues at contact centers. The intelligent assistance system not only assists a contact center agent to engage with a user, but also assists a contact center supervisor to oversee multiple interactions between contact center agents and users.

This illustrative example is given to introduce the reader to the general subject matter discussed herein and the disclosure is not limited to this example. The following sections describe various additional non-limiting examples of AI assistance for contact centers.

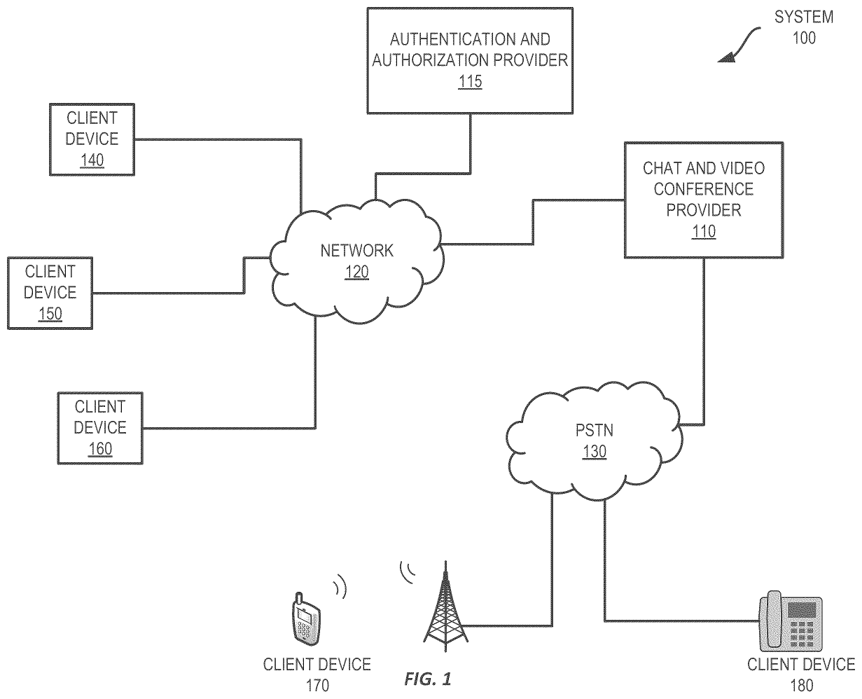

Referring now to FIG. 1, FIG. 1 shows an example system 100 that provides chat and videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

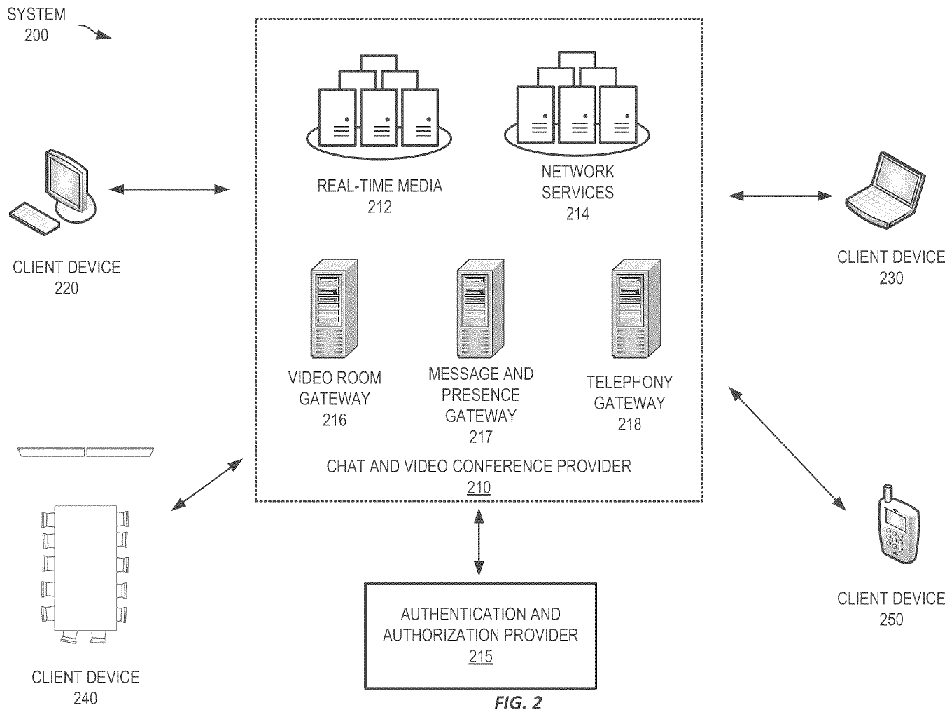

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a chat and video conference provider 210 provides chat and videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices'participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

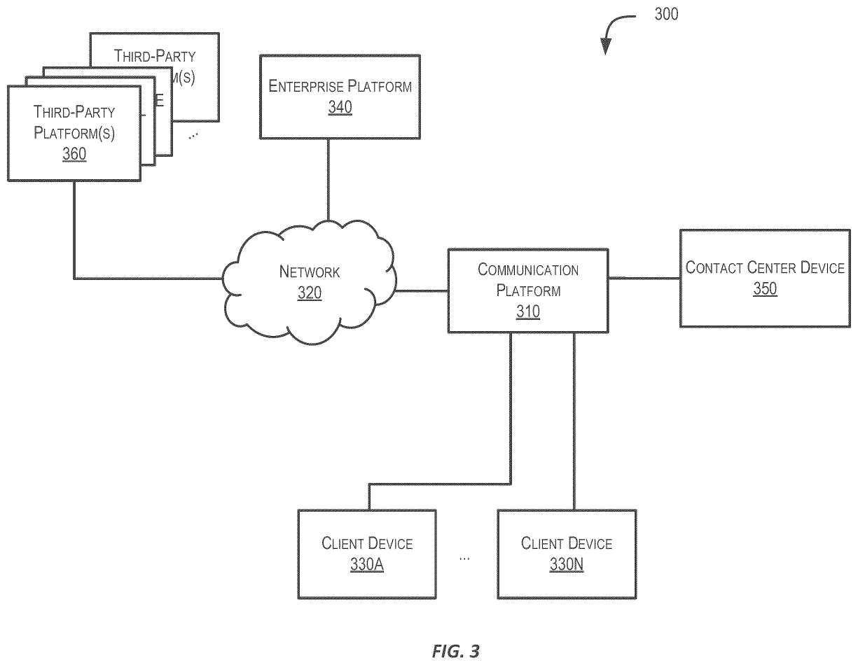

Referring now to FIG. 3, FIG. 3 shows an example system 300 for facilitating virtual communication between client devices and contact centers. In this example system 300, a number of client device 330A-330N (which may be referred to herein individually as a client device 330 or collectively as the client devices 330) communicate with a contact center device 350 over a communication platform 310. The communication platform 310 is connected with an enterprise platform 340 or one or more third-party platforms 360 via network 320. In this example, the network 320 is the internet, however, any suitable communications network or combination of communications network may be employed, including LANs (e.g., within a corporate private LAN) and WANs. The enterprise platform 340 provides certain products or services. The third-party platforms 360 can be any suitable platform that can provide information for a contact center device 350 to communicate with a client device 330.

The communication platform 310 can be the chat and video conference provider 110 illustrated in FIG. 1 or the chat and video conference provider 210 illustrated in FIG. 2. The communication platform 310 can provide one or more communication channels, for example video conferencing, phone calls, chat channels, emails, and other suitable communication means. For video conferencing, users (e.g., contact center, users associated client devices, streaming hosts) can create a virtual meeting room that can be represented by a video conferencing link or a meeting room number.

The client devices 330 and the contact center device 350 can be client devices 140-160 illustrated in FIG. 1 or client devices 220-250 illustrated in FIG. 2. The client devices 330 and the contact center device 350 can be any suitable computing or communications device. For example, client devices 330 may be desktop computers, laptop computers, tablets, smart phones having processors, computer-readable media, camera, and microphone. The client devices 330 and the contact center device 350 have a communication software or application (not shown) provided by the communication platform 310 installed to enable communication via the communication platform 310.

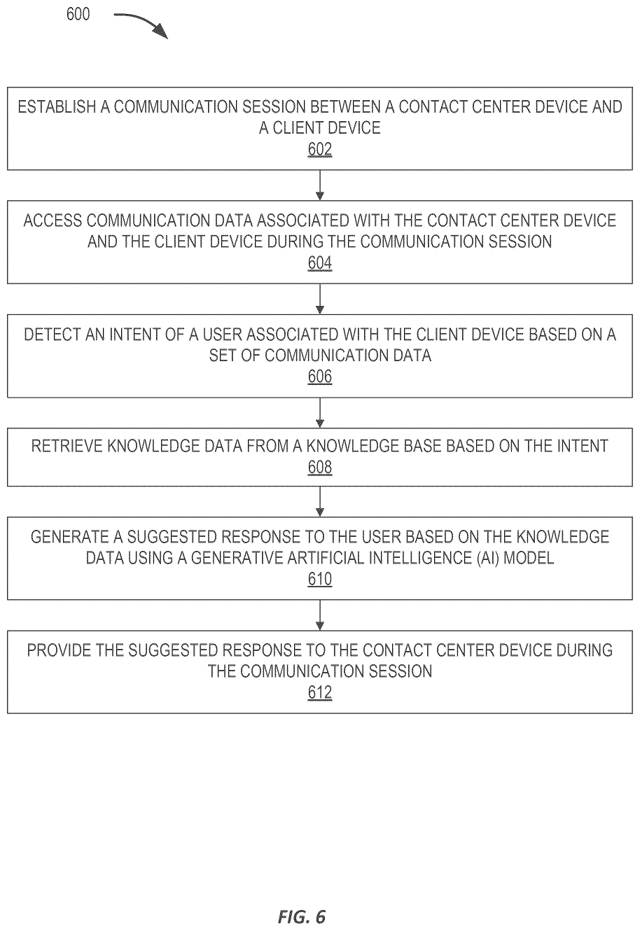

A client device 330 associated with a potential participant can initially connect with the contact center device 350 associated with the contact center for a live stream session via a communication channel provided by the communication platform 310, for example phone calls, emails, chat, etc. The client device 330 can then join a video conference with the contact center device 350 established by the communication platform 310. Details about the communications between the client devices 330 and contact center device 350 will be discussed in more detail in FIG. 6 below.

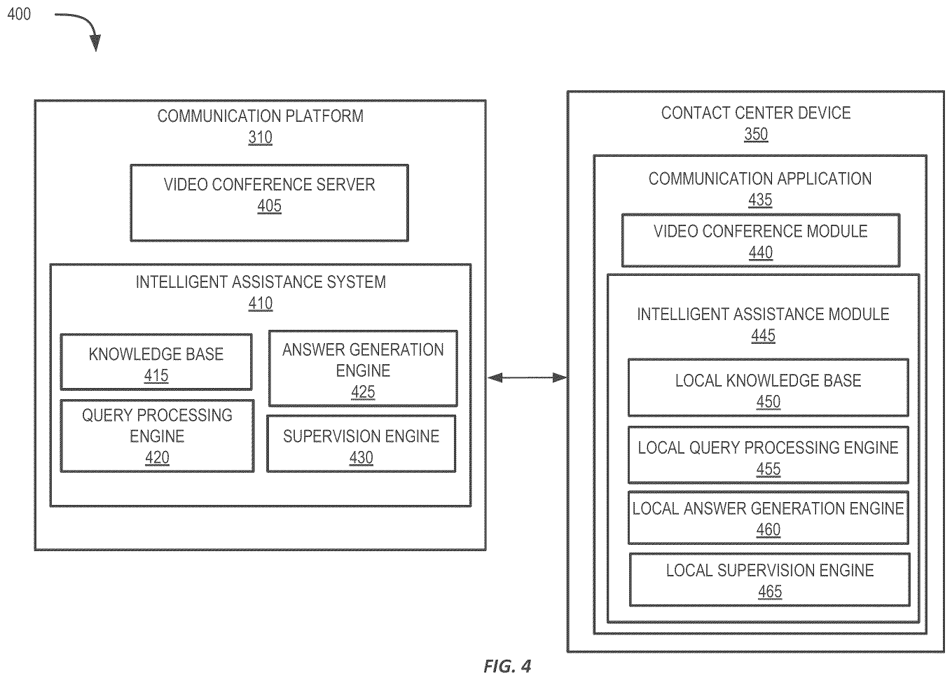

Referring now to FIG. 4, FIG. 4 shows an example system 400 that is configured to provide AI assistance for contact centers. The communication platform 310 is in network communication with a contact center device 350 installed with a communication application 435. The communication platform 310 includes a video conference server 405 and an intelligent assistance system 410. The video conference server 405 is configured to provide video conferencing, chat, phone call, and other suitable communication functionalities. The intelligent assistance system 410 includes a knowledge base 415, a query processing engine 420, an answer generation engine 425, and a supervision engine 430.

The intelligent assistance system 410 is configured to guide, assist, and evaluate a contact center agent using one or more AI models during the interaction between the agent and a user. The AI models in the intelligent assistance system are customized or fine-tuned using part or all of the data from the knowledge base 415 associated with the corresponding enterprise. For example, the intelligent assistance system 410 for a particular enterprise contact center identifies a script or certain knowledge data in a knowledge base associated with the enterprise to solve the user's issues based on the detected intent. The intelligent assistance system 410 uses or implements one or more AI models to analyze the interaction between a contact center agent and a user to guide the contact center agent to the relevant next step based on the script.

The knowledge base 415 includes knowledge data associated with an enterprise and scripts used for solving known user issues. The knowledge data includes articles, webpages, reports, manuals, or other suitable formats of data associated with the enterprise. The scripts can be pre-generated by operators associated with the enterprise, including steps for solving known user issues. In some examples, the knowledge base 415 also stores certain data from a verified third-party platform. In some examples, the intelligent assistance system 410 retrieves data from the verified third-party platform directly, for example via application programming interface (API).

The query processing engine 420 is configured to rephrase or rewrite a user query. When a user utters a question over the phone or types a question in a chat, the query processing engine 420 uses or implements one or more AI/ML models as intent models to understand the intent and context of the user query. The one or more AI/ML models include ML-based based classification models (e.g., transformer models or convolutional neural network (CNN)) trained to detect or predict an intent based on the user query and the context of the user query. In some examples, an LLM is used as an intent model to detect an intent from a user query and the context of the user query. The context can be multiple (e.g., up to 5) previous interactions from the current engagement. The query processing engine 420 also uses a generative AI model to rephrase or rewrite the user query based on the intent identified based on the user query and the context, so that the rewritten user query reflects the real intent of the user.

The answer generation engine 425 is configured to generate a suggested answer to a user query. The answer generation engine 425 uses or implements a search model, for example an embedding model, to retrieve relevant knowledge data from the knowledge base 415 based on the received user query and the rewritten user query using a retrieval-augmented generation (RAG) framework. For example, the embedding model vectorizes the knowledge data and the rewritten query into embedding vectors. The embedding model calculates a similarity score for a set of knowledge data with respect to the received user query and the rewritten user query, ranks the knowledge data based on their corresponding similarity scores, and retrieves the knowledge data with similarity scores satisfying a score threshold or with ranks satisfying a rank threshold. For example, the relevant knowledge data includes up to 5 articles identified to be relevant to the received user query and the rewritten user query. The answer generation engine 425 also uses or implements a generative AI model to generate a suggested answer, based on the rewritten user query, the retrieved knowledge data, the context of the user query, and a prompt. The generative AI model can be a generative pre-trained transformer (GPT) model or its variant or any other suitable LLMs. The prompt is an instruction to a generative AI model. The prompt instructs the generative AI model how to respond. An example prompt is “please generate a suggested response to a user question for the contact center agent based on provided information.” To prevent hallucination and inconsistency of the generative AI model for answer generation, the prompt can include specific instructions for the generative AI model to use only information provided. The information provided to the generative AI model for generating a suggested answer includes the retrieved knowledge data, the rewritten query, and the context of the query. Once the generative AI model generates suggested answers, the answer generation engine 425 or another module of the intelligent assistance system 410 uses or implements a answer evaluation model to verify that the suggested answers are from enterprise trusted knowledge and are accurate and coherent with respect to the user query. This way, the suggested answer provided to the contact center agent is more accurate and reliant.

The supervision engine 430 is configured to monitor the interactions between a contact center agent and a user and evaluate the performance of the contact center agent. For example, the supervision engine 430 monitors the communication between the agent and the user by analyzing the communication data to obtain analytics data. The supervision engine 430 may detect an anomaly in the communication session and generate a notification to transmit to a contact center supervisor device. The anomalies can be pre-defined in different categories, including but not limited to user sentiment, content moderation, or handle time. In some examples, the supervision engine 430 monitors the user sentiment (e.g., negative, positive, neutral, angry, happy). The supervision engine 430 can use or implement an AI/ML model to generate a sentiment score. The trained AI/ML model is pre-trained with labeled dataset of text and pre-assigned sentiment values to learn patterns in the text that indicate sentiment. The higher the sentiment score is, the more positive the sentiment is. If the sentiment score is below a predetermined threshold, the supervision engine 430 generates and transmits a notification to the supervisor for intervention. In some examples, the supervision engine 430 monitors the interaction between the contact center agent and the user for interaction moderation, using a keyword detection model. If the user mentions certain words, for example related to legal implication or indecency, either from the contact center agent or the user, the supervision engine 430 generates a notification to the supervisor of the contact center for intervention. In some examples, the supervision engine 430 monitors the length of the communications sessions. If the communication session lasts longer than a predetermined threshold (e.g., 1 hour), the supervision engine 430 sends a notification to a contact center supervisor device.

In some examples, the supervision engine 430 also evaluates the agent behavior or performance. For example, the supervision engine 430 determines how much (e.g., 80% of the time) the agent has followed the suggested answers or script during a communication session between the content center agent and the user. The supervision engine 430 also identifies the result of the communication session, for example, if the agent solved the user's issues. The supervision engine 430 also determines the handle time of the communication session. In some examples, the supervision engine 430 prompts a user to provide feedback at the end of the communication session with the contact center agent. For example, a user can select a thumbs up or thumbs down in a GUI, click a number of stars out of 5 stars, or select a score from 0 to 5. The supervision engine 430 determines a customer satisfaction score, for example based on user feedback data. In some examples, the supervision engine 430 prompts the agent to provide feedback on the suggested answers during or at the end of the communication session. For example, the contact center agent provides a thumbs up or a thumbs down to a recommended next step or a suggested answer. The feedback data and the evaluation data can be used to fine-tune the AI models of the supervision engine 430 or update the knowledge base 415. If the contact center agent solves the user's issues using a different approach with less time and better result, the supervision engine 430 generates an updated script for such kind of user issues based on recorded interactions between the contact center agent and the user, and provides to an operator of the contact center or the corresponding enterprise. The operator can select to edit, accept, or discard the updated script. If the operator selects to edit and accept the updated script, the updated script can be stored in the knowledge base 415 to replace the original script for the same user issue.

In some examples, the intelligent assistance system 410 detects that a user issue does not have a corresponding pre-generated script in the knowledge base 415 for guiding the agent. The intelligent assistance system 410 uses or implements a generative AI model to analyze the interaction between the agent and the user. If the agent solves the user issue, such as based on providing user responses during the interaction to the generative AI model and asking whether the user indicates that the issue is resolved, the generative AI model uses a transcript of a voice of video conference or a message history of interactions between the user and the agent to generate a script for the user issue, and provides an operator of the contact center or the corresponding enterprise. For example, the system 410 may generate a prompt to a generative AI model to create a script to resolve the identified issue and provide the transcript or message history to the generative AI model. The operator can later edit or approve the generated script and store the new script in the knowledge base 415.

The intelligent assistance system 410, including the knowledge base 415, the query processing engine 420, the answer generation engine 425, and the supervision engine 430, is customized for an enterprise contact center. The communication platform 310 can provides multiple intelligent assistance systems 410 customized for different enterprise contact centers.

The communication application 435 installed on the contact center device 350 can include a video conference module 440 and an intelligent assistance module 445. The video conference module 440 is configured to facilitate a contact center agent to host or join a video conference, a phone call, or a chat session with a user. The intelligent assistance module 445 can be a local version of the intelligent assistance system 410 on the communication platform 310. The intelligent assistance module 445 can include a local knowledge base 450, a local query processing engine 455, a local answer generation engine 460, and a local supervision engine 465, similar to those in the intelligent assistance system 410 as described above. The intelligent assistance module 445 can provide AI assistance to a contact center agent when engaging with a user. The communication application 435 also provides a graphical user interface (GUI) for a contact center agent to join or start a communication session with a user. Recommended next steps or suggested answers can be provided to the contact center agent in the GUI.

In an example, a user tries to join a meeting via a GUI on a similar communication application provided by communication platform 310 and installed on the client device 330 associated with the user. The communication application installed on the client device 330 includes a video conference module for establishing communication sessions. The user can send a request via webpage or a GUI of the communication application to start a communication session with the contact center associated with an enterprise. A contact center agent joins the communication session via a contact center device 350 to engage with the user, which triggers the intelligent assistance system 410 on the communication platform 310 or the intelligent assistance module 445 in the contact center device 350 to provide assistance to the contact center agent during the communication session.

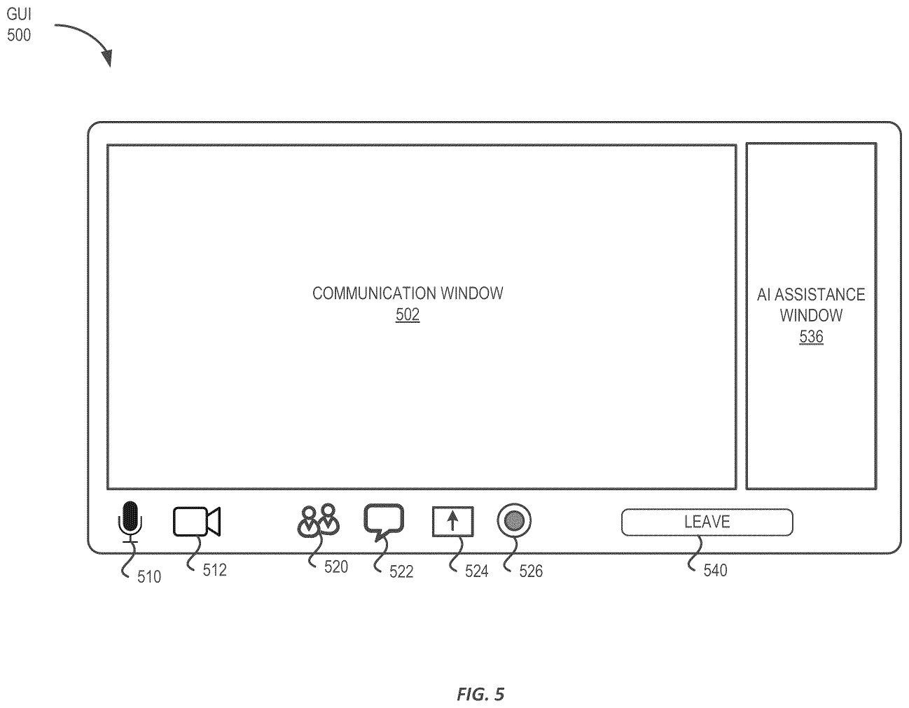

Referring now to FIG. 5, FIG. 5 shows an example GUI 500 for a communication session on a contact center device 350. A contact center device 350 associated with a contact center agent or a client device 330 associated with a user can start a communication session. The GUI 500 of the communication session can be displayed on a contact center device 350. The communication session can be a video conference, chat, phone call, or any other suitable communication formats. In this example, the communication session is a video conference. The GUI 500 includes a communication window 502 that presents video frames depicting the contact center agent or the user related to an enterprise. Beneath the communication window 502 are a number of interactive elements 510-526 to allow a contact center agent to control the communication session. Interactive elements 510 allows the contact center agent to toggle on or off audio streams. Interactive elements 512 allows the contact center agent to toggle on or off video streams. Interactive element 520 allows the contact center agent to view a list of virtual participants of the communication session. Interactive element 522 allows the contact center agent to send a chat message to a user during the video conference. Interactive element 524 allows the contact center agent to share content from the contact center device 350. Interactive element 526 allows the contact center agent to toggle recording of the communication session. The GUI also includes an AI assistance window 536 configured to display next steps or suggested answers to guide the contact center agent during the communication session with a user. Interactive element 540 allows the contact center agent to leave or end the communication session. Besides, other suitable interactive elements may be available in the GUI 500 for the contact center agent to manage or control the communication session.

Referring now to FIG. 6, FIG. 6 shows an example method 600 for providing AI assistance for contact centers. The example method 600 will be discussed with respect to system 300 shown in FIG. 3 and system 400 shown in FIG. 4; however, any suitable system for providing AI assistance for contact centers may be used.

At block 602, a communication platform 310 establishes a communication session between a contact center device 350 and a client device 330, generally as discussed above with respect to FIGS. 1-3. The video conference server 405 of the communication platform 310 provides video conferencing, phone calls, chats, and other suitable communication capabilities. In some examples, a user requests via a client device 330 a communication session with a contact center, for example a video conference. The video conference server 405 establishes the communication session between a contact center device 350 associated with a contact center agent and the client device 330 associated with the user.

At block 604, the communication platform 310 accesses communication data associated with the contact center device 350 and the client device 330 during the communication session generally as discussed above with respect to FIG. 4. During the communication session, the intelligent assistance system 410 of the communication platform 310 accesses communication data associated with the contact center device 350 and the client device 330. For example, the communication session is a video conference session. The communication data includes utterances from the contact center agent and the user and/or a utterance transcript.

At block 606, the communication platform 310 detects an intent of a user associated with the client device 330 based on the communication data generally as discussed above with respect to FIG. 4. For example, the query processing engine 420 of the intelligent assistance system 410 on the communication platform 310 identifies a user query from the utterance of the user. The query processing engine 420 uses or implements an intent engine to identify an intent based on the utterance and the context of the utterance. The query processing engine 420 also rephrases or rewrites the user query based on the context of the utterance. For example, the user asked: “what types of insurances do you provide?” The contact agent answered “car, boat, home.” The user then asks: “tell me more about the car.” To prevent any confusion for generating answers to the user query, the query processing engine 420 rewrites the user query as “tell me more about the car insurances.”

At block 608, the communication platform 310 retrieves knowledge data from a knowledge base based on the intent, generally as discussed above with respect to FIG. 4. For example, the answer generation engine 425 of the intelligent assistance system 410 uses a search model to retrieve relevant knowledge data from a knowledge base 415 based on the intent or the rewritten query. The search model ranks the knowledge data based on their similarities to the rewritten query. The search model retrieves the knowledge data with a similarity score higher than a threshold or a rank threshold. For example, the search model retrieves the top 5 articles that are most similar to the rewritten query.

At block 610, the communication platform 310 generates a suggested response to the user based on the knowledge data using a generative artificial intelligence (AI) model, generally as discussed above with respect to FIG. 4. The answer generation engine 425 of the intelligent assistance system 410 uses a generative AI model to generate a suggested response based on the retrieved knowledge data. In some examples, the rewritten query and the context of the query are also provided to the generative AI model. An example prompt for the generative AI model is “please generate a suggested response to a user based on provided information.” The information provided to the generative AI model for generating a suggested response includes the retrieved knowledge data, the rewritten query, and the context of the query.

At block 612, the communication platform 310 provides the suggested response to the contact center device 350 during the communication session. The answer generation engine 425 provides the suggested response to the contact center device 350. For example, the suggested response can be displayed in a GUI window of the contact center device 350. The GUI window is next to the communication window, as shown in FIG. 5.

The example process 600 illustrates a method for providing AI assistance for contact centers. However, not every step in the example process 600 may be needed, or some steps may be in a different order. The example process 600 is performed by a communication platform 310. Alternatively, the example process 600 can be performed by a communication application 435 installed on a contact center device 350.

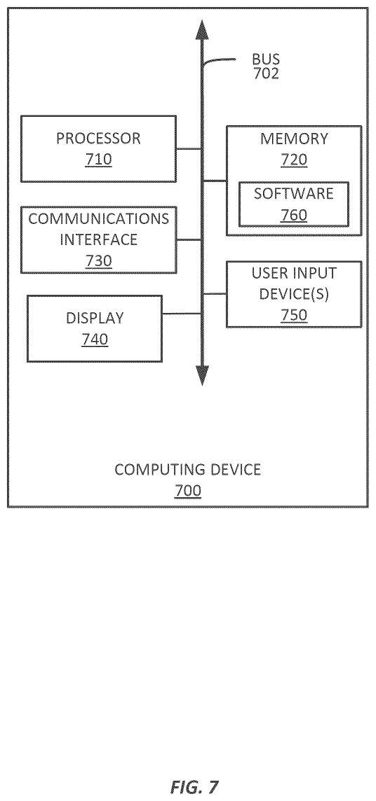

Referring now to FIG. 7, FIG. 7 shows an example computing device 800 suitable for use in example systems or methods for providing AI assistance for contact centers according to this disclosure. The example computing device 700 includes a processor 710 which is in communication with the memory 720 and other components of the computing device 700 using one or more communications buses 702. The processor 710 is configured to execute processor-executable instructions stored in the memory 720 to perform one or more methods for providing AI assistance for contact centers according to different examples, such as part or all of the example method 600 described above with respect to FIG. 6. In some embodiments, the computing device may include software 760 for executing one or more methods described herein, such as for example, one or more steps of method 600. The computing device 700, in this example, also includes one or more user input devices 750, such as a keyboard, mouse, touchscreen, microphone, etc., to accept user input. The computing device 700 also includes a display 740 to provide visual output to a user.

The computing device 700 also includes a communications interface 830. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
establishing a communication session between a contact center device and a client device;
accessing communication data associated with the contact center device and the client device during the communication session;
detecting an intent of a user associated with the client device based on a set of communication data;
retrieving knowledge data from a knowledge base based on the intent;
generating a suggested response to the user based on the knowledge data using a generative artificial intelligence (AI) model; and
providing the suggested response to the contact center device during the communication session.

2. The method of claim 1, further comprising:
analyzing the communication data to generate analytics data;
detecting an anomaly in the communication session based on the analytics data; and
transmitting a notification associated with the anomaly to a contact center supervisor device.

3. The method of claim 1, wherein detecting an intent of a user associated with
the client device based on a set of communication data comprising:
receiving a user query from the client device;
updating the user query based on context data associated with the user query to obtain an updated user query; and
detecting the intent of the user based on the updated user query.

4. The method of claim 1, wherein the knowledge base comprises a database associated with an enterprise providing a product or a service, wherein the communication session is associated with the product or the service provided by the enterprise.

5. The method of claim 1, further comprising retrieving the knowledge data from the knowledge base based on the intent using an embedding model.

6. The method of claim 1, further comprising:
identifying an agent script from the knowledge base based on the intent of the user associated with the client device, wherein the agent script comprises multiple instructional steps for solving a user issue associated with the intent; and
dynamically providing a next step to the contact center device based on the communication data.

7. The method of claim 1, further comprising:
evaluating a performance of a contact center agent associated with the contact center device during the communication session to obtain evaluation data.

8. The method of claim 1, wherein the intent is related to an unknown issue without a corresponding script in the knowledge base; wherein the method further comprises:
automatically generating a draft script for solving the unknown issue based on the communication data during the communication session.

9. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
establish a communication session between a contact center device and a client device;
access communication data associated with the contact center device and the client device during the communication session;
detect an intent of a user associated with the client device based on a set of communication data;
retrieve knowledge data from a knowledge base based on the intent;
generate a suggested response to the user based on the knowledge data using a generative artificial intelligence (AI) model; and
provide the suggested response to the contact center device during the communication session.

10. The system of claim 9, wherein the one or more processors are configured to execute further processor-executable instructions stored in the non-transitory computer-readable medium to:
analyze the communication data to obtain analytics data;
detect an anomaly in the communication session based on the analytics data; and
transmit a notification associated with the anomaly to a contact center supervisor device.

11. The system of claim 9, wherein the one or more processors are configured to execute further processor-executable instructions stored in the non-transitory computer-readable medium to:
receive a user query from the client device;
update the user query based on context data associated with the user query to obtain an updated user query; and
detect the intent of the user based on the updated user query.

12. The system of claim 9, wherein the knowledge base comprises a database associated with an enterprise providing a product or a service, wherein the communication session is associated with the product or the service provided by the enterprise.

13. The system of claim 9, wherein the one or more processors are configured to execute further processor-executable instructions stored in the non-transitory computer-readable medium to:
retrieve the knowledge data from the knowledge base based on the intent using an embedding model.

14. The system of claim 9, wherein the one or more processors are configured to execute further processor-executable instructions stored in the non-transitory computer-readable medium to:
identify an agent script from the knowledge base based on the intent of the user associated with the client device, wherein the agent script comprises multiple instructional steps for solving a user issue associated with the intent; and
dynamically provide a next step to the contact center device based on the communication data.

15. The system of claim 9, wherein the one or more processors are configured to execute further processor-executable instructions stored in the non-transitory computer-readable medium to:
evaluate a performance of a contact center agent associated with the contact center device during the communication session to obtain evaluation data.

16. A non-transitory computer-readable medium comprising processor-executable instructions configured to cause one or more processors to:
establish a communication session between a contact center device and a client device;
access communication data associated with the contact center device and the client device during the communication session;
detect an intent of a user associated with the client device based on a set of communication data;
retrieve knowledge data from a knowledge base based on the intent;
generate a suggested response to the user based on the knowledge data using a generative artificial intelligence (AI) model; and
provide the suggested response to the contact center device during the communication session.

17. The non-transitory computer-readable medium of claim 16, further comprising processor-executable instructions configured to cause one or more processors to:
analyze the communication data to obtain analytics data;
identify an anomaly in the communication session based on the analytics data; and
transmit a notification associated with the anomaly to a contact center supervisor device.

18. The non-transitory computer-readable medium of claim 17, further comprising processor-executable instructions configured to cause one or more processors to:
receive a user query from the client device;
update the user query based on context data associated with the user query to obtain an updated user query; and
detect the intent of the user based on the updated user query.

19. The non-transitory computer-readable medium of claim 17, further comprising processor-executable instructions configured to cause one or more processors to:
identify an agent script from the knowledge base based on the intent of the user associated with the client device, wherein the agent script comprises multiple instructional steps for solving a user issue associated with the intent; and
dynamically provide a next step to the contact center device based on the communication data.

20. The non-transitory computer-readable medium of claim 17, further comprising processor-executable instructions configured to cause one or more processors to:
evaluate a performance of a contact center agent associated with the contact center device during the communication session to obtain evaluation data.
